(19) United States
(12) Patent Application Publication
(10) Pub. No.: US 2008/0004677 A1
(43) Pub. Date: Jan. 3, 2008

(54) Hydrotherapy Vessel

(76) Inventor: Brian Gay, Patterson Lakes Victoria (AU)

Correspondence Address: Ralph A. Dowell of DOWELL & DOWELL P.C., 2111 Eisenhower Ave, Suite 406, Alexandria, VA, 22314, US

(21) Appl. No.: 10/592,423

(22) PCT Filed: Mar. 11, 2005
(86) PCT No.: PCT/AU05/00342

§ 371 Date: Aug. 10, 2007

(30) Foreign Application Priority Data
Mar. 11, 2004 (AU) 2004901291

(51) Int. Cl. A61H 33/00; A41D 7/00; A47K 3/00

(52) U.S. Cl. 607/85; 2/67; 4/541.1; 4/556; 4/584; 601/154; 601/158

(57) ABSTRACT

A hydrotherapy vessel (10) that allows the user (42) to experience hydrotherapy in an upright position. The vessel provides means (50) for the user to enter the vessel laterally, rather than the traditional method of entering from the top of the vessel. Also provided is a liner (18, 32) that can be used to line the vessel to ensure watertightness, and a sheath (44) that may enclose the user so that the user does not directly contact the water (34).

### FIELD

The present invention relates to the field of hydrotherapy vessels. More specifically the present invention relates to the construction of hydrotherapy vessels that are capable of being installed in a wide range of environments and are easily transported.

### BACKGROUND

Hydrotherapy is essentially the use of water for the purposes of healing, relaxation or stimulation of the mind or body. Hydrotherapy may rely on the buoyancy, warmth, and effects of water pressure and turbulence to speed recovery after surgery, reduce pain and stress, spasm and discomfort. It is especially beneficial for people with work-related or sports injuries, arthritis, neck, back, or knee pain, hyperthermia, hypothermia and more. Hydrotherapy is also well used for relaxation or stimulation of the mind.

The temperature of water used during hydrotherapy affects the therapeutic outcome of the treatment. Hot water is chosen for its relaxing properties, as well as its ability to stimulate the immune system. Tepid water can also be used for stress reduction, and may be particularly relaxing in hot weather. Cold water is selected to reduce inflammation. Alternating hot and cold water can stimulate the circulatory system and improve the immune system. Adding herbs and essential oils to water or directly to the patient can enhance its therapeutic value. Steam is frequently used as a carrier for essential oils that are inhaled to treat respiratory problems.

The therapeutic use of water has a long history. Ruins of ancient baths were unearthed in Pakistan and date as far back as 4500 B.C. Similarly, bathhouses were an essential part of ancient Roman culture with the use of baths, and aromatic massage to promote well being is documented since the first century.

By the seventeenth and eighteenth centuries, bathhouses were extremely popular with the public throughout Europe. Public bathhouses made their first American appearance in the mid 1700s.

Given the popularity and success of hydrotherapy throughout history, it is little wonder that spa baths, Jacuzzis and the like have found their way into modern health clubs as well as the domestic environment. Modern forms of hydrotherapy now include:

Whirlpools, Jacuzzis, and Hot Tubs.

These soaking tubs use jet streams to massage the body. They are frequently used by physical therapists to help injured patients regain muscle strength and to soothe joint and muscle pain. Some midwives and obstetricians also approve of the use of hot tubs to soothe the pain of labour. These vessels may be of a depth sufficient only to allow a user to be fully immersed in a reclining position, or may be deep enough to allow a user to experience hydrotherapy while upright.

Flotation Tanks.

These vessels are often used for relaxation or sensory deprivation. The vessel is designed for the user to float in a supine position, with flotation assisted by dissolved salts in the water. There is often a hood or cover, leading to a completely dark and quiet environment.

Pools and Hubbard Tanks.

Physical therapists and rehabilitation specialists may prescribe underwater pool exercises as a low-impact method of rebuilding muscle strength in injured patients. The buoyancy experienced during pool immersion also helps ease pain in conditions such as arthritis.

Baths.

Tepid baths are prescribed to reduce a fever. Baths are also one of the oldest forms of relaxation therapy. Aromatherapists often recommend adding essential oils of lavender (Lavandula angustifolia) to a warm to hot bath to promote relaxation and stress reduction. Adding Epsom salts (magnesium sulfate) or Dead Sea salts to a bath can also promote relaxation and soothe rheumatism and arthritis.

A problem of the hydrotherapy vessels of the prior art is that installation into modern buildings can be problematic. The constraints of headroom space available in modern dwellings, and the inability to sink a spa on an upper story or in a concrete slab on the ground floor have caused problems in the past. These problems are exacerbated if the vessel is very deep, as is required for upright hydrotherapy.

Another problem of hydrotherapy vessels is that they are difficult to access, especially by the elderly who are often in the greatest need of therapy. For example, the user must climb over the upper edge of the vessel and lower themselves in. Further problems are encountered when the user must exit the vessel, with the added danger of the user slipping due to the presence of water on the body and the surfaces of the vessel. This situation may be particularly dangerous where the upper edge of the vessel is a considerable height above the ground as may be the case in, vessels designed for upright hydrotherapy. Furthermore, sufferers of chronic back pain and other conditions that inhibit free movement and bending of the back have great difficulty in entering hydrotherapy vessels.

It is an aspect of the present invention to overcome a problem of the prior art by providing a spa construction allowing easy installation in many environments irrespective of the dimensions or construction of the room, and also allowing easy access.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed in Australia before the priority date of each claim of this application.

### IN THE FIGURES

FIG. 1 illustrates a cross-section through the line A-A of FIG. 2A of an exemplary embodiment of the present invention.

FIG. 2A illustrates a plan view of an exemplary embodiment of the present invention as shown in FIG. 1.

FIG. 2B illustrates a perspective view of a sheath included in an exemplary embodiment of the present invention.

FIG. 3 illustrates a lateral view of a door assembly.

FIG. 4 illustrates a plan view of the door assembly shown in FIG. 3.

### SUMMARY OF THE INVENTION

In one aspect the present invention provides a substantially watertight hydrotherapy vessel including a wall, the wall defining an interior, the wall including means for allowing lateral entry of a user into the vessel, wherein the vessel is of a depth sufficient to allow upright hydrotherapy. As used herein the term “upright hydrotherapy” is intended to include any hydrotherapeutic method whereby the user's body is not in a supine position. The term is intended to include the case whereby the user's body is in a substantially extended state and in a substantially upright position. This includes methods whereby the user's body is in a substantially extended state and substantially perpendicular to the ground at some stage during the hydrotherapy session. Also included is the situation whereby the user is substantially extended with the line of the body defining an angle of at least about 20 degrees with the ground at some point during the hydrotherapy session. The term “upright hydrotherapy” also includes a hydrotherapy method whereby the body of the user is still substantially upright but not in a substantially extended position (i.e. in a partially contracted state). An example of this would be where the knees are drawn close to the chest, but the user is still substantially upright.

To the best of the Applicant's knowledge, nowhere in the prior art is there described a hydrotherapy vessel designed for upright hydrotherapy including a wall including means for allowing lateral entry to the vessel. This is distinct to all other hydrotherapy vessels known in the art that rely on a user entering and exiting the vessel over the upper edge of the vessel.

In a preferred form of the invention the hydrotherapy vessel is capable of containing water to a depth allowing the user to float free of the floor of the vessel. Of course, this level will vary according to the height of the user. In one form of the invention the vessel is capable of containing water to a depth of more than about 1.2 metres. In a particularly preferred form of the invention the vessel is capable of containing water to a depth of more than about 2 metres. In another preferred embodiment the vessel is capable of containing water to a depth of more than about 2.2 metres.

Preferably the means for allowing lateral entry of a user includes means for sealing the means for allowing lateral entry. In a further preferred form of the invention, the wall includes means for sealing the means for allowing lateral entry to the vessel.

Applicants have discovered that a number of significant advantages are provided by hydrotherapy vessels subject of this specification. One advantage relates to the ability to easily install a deep vessel, of the type suitable for hydrotherapy of a subject in an upright position. Such devices may be up to 2.2 metres deep in order to accommodate a particularly tall person. In installing a device of this height ft would normally be necessary to excavate a hole of substantial depth. In rooms where it is not possible to excavate, the vessel may be installed directly onto the floor. However this approach often raises the further problem of there being insufficient clearance thereby prohibiting access by the user. The present invention overcomes these problems by providing a hydrotherapy vessel designed to allow upright hydrotherapy that allows the user to enter the vessel laterally, rather than the usual method of climbing over an upper edge of the vessel. Lateral entry is achieved by the inclusion of a means for entry in the wall of the hydrotherapy vessel.

A further significant advantage of the present invention is that it affords easy access for the old, incapacitated, handicapped or infirm to the hydrotherapy vessel.

In use, at the commencement of the hydrotherapy session the vessel is empty or substantially empty of water, and the user is outside the vessel. Upon commencement of the session the user enters the interior of the vessel via the means for allowing lateral entry. Once the user is inside, the vessel is made substantially watertight by sealing the means for allowing entry. Once the seal is made, the vessel is filled with water (or other liquid). At the conclusion of the hydrotherapy session, water is removed from the interior of the vessel, and the user may then exit the vessel via the means for allowing lateral entry.

It will be clear that by implementing a hydrotherapy vessel as described herein it is possible for a user to avoid the need to enter the device over the upper edge of the wall of the vessel.

As described above, the vessel includes a wall, with the wall generally defining an interior region of the vessel. The wall may be of unitary construction, or may be fabricated in panels for ease of transport. Suitable materials for construction of the wall include glass, fibreglass, or plastics such as polypropylene, polyethylene, polyvinylchloride and the like. Metals such as aluminium or stainless steel may also be used. In one embodiment of the invention, the function of the wall is to act as a watertight barrier to retain water in the vessel. In another embodiment, a plastic liner may be used inside the vessel as a watertight barrier with the wall acting structurally to oppose the hydrostatic pressure exerted on the walls of the liner.

In a preferred form of the invention, the wall of the hydrotherapy vessel is adapted to store water. In this construction, the function of the wall is two-fold in that it has a structural role, and also a role in the water handling of the vessel. For example the wall may be of a cavity construction, leaving a significant volume of empty space between the inner and outer wall. In a further preferred form of the invention the floor of the vessel is also adapted to store water and allow delivery of water to the vessel.

The skilled person will understand that it is not strictly necessary for the water storage tanks to be incorporated into the vessel structure per se. Water may be stored adjacent to or remotely from the vessel. Indeed, it would not even be necessary to use tanks for supplying water to the vessel. The water may be obtained from the general town water supply, or even pumped from a natural reservoir such as the ocean.

A major advantage of using tanks for the storage of water is that it is now possible to provide a completely portable hydrotherapy vessel that is not reliant on the presence of plumbing for set up. A hydrotherapy vessel of this construction could be placed in an office, for example, for short term use.

It is also possible to use less rigid materials that have the ability to become rigid in construction of the wall. For example, the wall of the vessel may be of an inflatable construction that may be filled with air or water to become substantially rigid. This arrangement will be advantageous in allowing the vessel to be folded for storage or transport.

Included in the wall is means for allowing lateral access to the vessel. In one form of the invention the means for allowing access is a hinged door capable of forming a watertight seal with the wall when closed. The skilled person will be sufficiently enabled to identify and implement any number of arrangements that will lead to the desired sealing.

Alternatively, the means for allowing entry may simply be an aperture in the wall. This embodiment will be useful where a liner is used to retain water in the vessel. It is contemplated that a user could enter the vessel via the aperture and step into the liner. The liner is then raised to a sufficient height depending upon the water depth required, and then filled with water. In this context a function of the wall is to oppose the hydrostatic pressure on the liner, and so the aperture could not be so large as to allow extrusion of the liner through the aperture.

The means for allowing entry may or may not be completely surrounded by the wall. For example, the means for allowing entry may be a hinged door, with the upper edge of the door being at the same height as the upper edge of the hydrotherapy vessel. In this embodiment the wall is in contact with only three sides of the door. In a preferred form of the invention however, the wall completely surrounds the means for allowing entry.

In a preferred form of the invention the door is designed so that it is able to swing both inwardly and outwardly. It is important that the door is able to swing outwardly such that if a user loses consciousness in the vessel and slumps against the door, there will be no way to access and remove the user from the vessel. A simple and economical type of door that is amenable to use in the present invention is of the type whereby the door is larger than the aperture for which it is designed to seal, such that there is a border region around the aperture where the door makes sealing contact with the aperture surrounds. Typically, the door is mounted inside the vessel. When the vessel is filled with water a seal is created by the exertion of hydrostatic pressure from inside the vessel pushing the door firmly against the aperture surrounds thereby creating a seal. Typically, there is a tract of rubber or silicone around the aperture to ensure a good seal. Thus, the door seals only when it is necessary, that is when there is fluid inside the vessel.

A problem arises with this type of door in that it is not possible to open the door in an outwards direction due to the fact that the door is by necessity larger than the aperture to which it is fitted. This is an undesirable situation to which, to the best of the Applicants knowledge, the prior art has provided no simple solution.

Accordingly, in a preferred form of the invention the vessel includes a door and hinge assembly adapted to be mounted on a surface, the surface having an aperture, the door being of a size sufficient to completely cover the aperture, the assembly including
means for increasing a length of the aperture along a first axis,
means for altering the position of the door either laterally or longitudinally relative to the aperture, and
means for allowing the door to pivot along a second axis
wherein in operation the door is capable of passing through the aperture by increasing a length of the aperture along the first axis, altering the position of the door laterally or longitudinally, and pivoting the door on the second axis.

Applicants have provided a solution to the problem of being unable to outwardly open a door that is larger than the aperture to which it is fitted. Where this contrivance is used on a hydrotherapy vessel, the advantage is noted where the user of the vessel loses consciousness and slumps against the door. Since the door now cannot be opened inwards, use of the present invention allows the door to open outwards, thereby providing access to the unconscious user. A further advantage is seen where the hydrotherapy vessel includes a large piece of exercise equipment such as a bicycle in which case the door is also prevented from opening inwards.

Reference to “a length” of the aperture is intended to also include a width of the aperture. A length of the aperture may be increased in a number of ways such as by folding away a hingedly attached portion of the structure in which the aperture resides, or alternatively by removing a removable panel in the structure. Alternatively (and where the aperture is rectangular for example) the length of the aperture may be increased infinitely such that the aperture consists only of three edges. In certain situations this may even be necessary to allow other structures associated with the door (such as the hinge) to swing outwards with the door. In a preferred form of the invention a length of the aperture is increased by removing a removable panel normal present on an edge of the aperture. Preferably the removable panel is removed from an upper edge of the aperture.

The net effect of increasing a length or width of the aperture is to remove an impediment to the door passing through the aperture in one dimension the length or width).

The means for laterally or longitudinally adjusting the door relative to the aperture may be located on the door, hinge, aperture or surface or a combination of any of these. The means may simply be the door itself such that the user grasps the door and adjusts its position up or down, left or right directly. The means may be a handle attached to the door that may be grasped by the user to assist in adjusting the door. Alternatively, the means for adjusting the position of the door could be a lever attached to the surface that actuates against the door, or it may be a lever attached to the door that actuates against the surface. In a preferred form of the invention the means is a lever that actuates against the central spindle of the hinge. Since the spindle of the hinge is in contact with the door, the door moves in concert with the spindle. The lift may be actuated by a spring or by an electric servo motor for example. The skilled person will be amply enabled to conceive of other means for adjusting the position of the door and all are included herein.

The pivot means may be any contrivance that allows the door to pivot along an axis. Preferably the pivot means is a swivel joint mounted on an upper edge of the door. Preferably the pivot means is located on a central axis of the door. The pivot may allow the door to pivot horizontally or vertically, but preferably it allows vertical pivoting.

Typically, but not necessarily the first axis is perpendicular to the second axis.

While the invention has been described by assuming that both door and aperture are rectangular, the skilled artisan will be able to apply the general principles described herein to other geometric shapes such as circles, diamonds, squares, triangles and even irregular shapes.

Preferably the vessel of the present invention includes a substantially water tight inner liner capable of moving up and down. In this embodiment it is not necessary for the wall and means for allowing entry form a watertight seal since the liner is able to prevent the egress of water from the vessel. Of course, the skilled artisan will understand that where the means for allowing entry is simply an aperture there will be an upper limit to the size of the aperture, and a lower limit an the rigidity of the liner. Incorrect consideration of these parameters will lead to an undue amount of hydrostatic pressure being applied to the liner without support form the wall, leading to rupture of the liner.

Many known hydrotherapy vessels capable of allowing upright hydrotherapy could be adapted to include means for allowing lateral entry of a user. The present invention includes existing vessels that have been adapted in this way.

The hydrotherapy vessels of the present invention are suitable for treatments where the user remains in a substantially upright position during the treatment. This is distinct from a regular spa baths where the user is often seated, or a flotation tank where the user is in a supine position. The advantages of an upright hydrotherapy vessel are that less floor space is required. The small footprint means it is easy to transport, it is therefore more attractive as a lease or rental item. From a therapeutic aspect, users report that the sensation of floating upright, balanced, and being compressed from all directions by hydrostatic pressure is unique and available only from an upright hydrotherapy vessel.

Of course, it is not necessary for the hydrotherapy vessel of the present invention to be portable. The hydrotherapy vessel may be permanently installed and connected to mains water, and to sewerage for drainage. For example, if the hydrotherapy vessel includes a shower to wash the body after therapy, then the vessel may include a drain that is connected to the sewer.

It is also unnecessary for the hydrotherapy vessel to be capable of accommodating a user in an upright position.

As an example of the hydrotherapy vessel in use, the following is provided. At commencement of the therapy session, the user may have any number of lotions, moisturisers, therapeutic compositions or the like applied to the body. The user then enters the hydrotherapy vessel via the door in the wall of the vessel and stands inside the sheath. The door is then closed, making a watertight seal between the wall and the door. Pre-warmed water stored in the cavity of the vessel wall or any other water storage or supply means begins to enter the cavity with the assistance of a pump. As the water rises, the rim of the sheath concurrently rises due to the buoyant rim on the sheath. The water continues filling until a predetermined level is reached (generally 80% of the total capacity of the vessel). As the water level rises, the users body is compressed by the water, and also lifted due to buoyancy. Once the vessel has filled, the user is suspended in the water having been completely lifted off the floor of the vessel. The user or therapist may then activate hydrotherapy jets (or indeed any other means of stimulating the body) to massage the body of the user.

During the therapy session the user may be exposed to turbulence generated by water jets for example. This provides a massaging effect similar to that encountered in a spa bath.

The hydrotherapy vessels of the present invention may be fitted with a range of accessories such as water heaters, water filters, recirculation pumps, jets and the like. The vessel may also include other hardware such as a shower head, spray jets for the application of artificial tanning compositions, or a seat.

The vessels of the present invention method may also be equipped to provide a range of other modalities such as light therapy or music therapy for example. Preferably, the means for delivering light or music therapy are integral with the apparatus of the present invention, with suitable arrangements of lights and speakers being demonstrated in U.S. Pat. No. 5,645,578. The hydrotherapy vessel may also include other hardware such as a DVD player and screen. Addition of these or other multimedia components opens the possibility that a user could also have an educational experience while in the vessel. It is contemplated that the relaxation or stimulation provided in the vessel will allow a user to more easily assimilate information.

Where the vessel is to be used for relaxation or sensory deprivation, a hood or cover may be included to exclude or contain sound, light, steam, mist vapours or aromas introduced into the vessel as part of the therapy or experience.

The vessel may also include means for administering gases or vapours to the user to effect aromatherapy, oxygen therapy or ozone therapy. The skilled person will be sufficiently conversant with nebulisers, vaporisers, gas flow regulators and the like to put this form of the invention into practical effect.

The hydrotherapy vessel of the present invention may also include means for causing vibrations or pressure waves in the water. This may be accomplished by exposing the water to subsonic, sonic or ultrasonic vibrations. The waveforms used may be synthetic (e.g. sine wave, square wave, triangular wave, or sawtooth wave) or may be of natural origin (e.g. whale or bird “songs”, sounds of the forest, sounds of flowing water). One way of setting up the appropriate vibrations or pressure waves in the water is to use a speaker adapted for use under water. Ultimately, however, any moving surface is capable of causing the requisite vibrations or pressure waves may be used and is therefore included in the scope of the invention. Vibrations or pressure waves may also be introduced into the water by injecting a gas or a fluid.

A further feature that may be incorporated is a mirror. Users of hydrotherapy vessels, and especially enclosed hydrotherapy vessels may feel claustrophobic during a treatment session. This feeling may be overcome by including a mirror above the user that reflects an image of the surrounding environment to the user. The mirror may be a simple planar mirror, or could be a convex mirror to reflect a wider view of the surroundings. Also to assist a potentially claustrophobic or otherwise fearful user an intercom system may be provided to allow communication with the attendant. It may also provide a sense of security if a “panic” button in included such that upon activation the vessel drains and the door is opened.

Another feature that may be used with the hydrotherapy vessels described herein is a flexible sheath that surrounds the user during the hydrotherapy session. It should be clear however, that the hydrotherapy vessels of the present invention may be used without the sheath. The sheath may be any shape capable of receiving a user, but is preferably generally sock-shaped, having an opening at one end adapted to allow entry of the user. Preferably the sheath is composed of a material of minimal thickness and with sufficient flexibility and heat transfer properties to allow the wall of the sheath to closely conform to the contours of the body, and to allow the sensation of pressure and temperature to the skin.

The sheath may include means for maintaining the rim of the sheath above the surface of the water. In a preferred form of the invention the means for maintaining the rim above the surface of the water is a buoyant ring fixed to the open end of the sheath. This arrangement keeps the user substantially dry throughout the hydrotherapy treatment. In a more highly preferred form of the invention the ring can be detached from the sheath such that a used sheath may be discarded, while the ring is reused and attached to a fresh sheath.

The use of a sheath provides the further advantage that the user is able to stay completely dry during an upright hydrotherapy treatment. This feature will encourage the use of vessels of the present invention in environments where users may be reticent about removing their clothing such as in airports, shopping centres, train stations, sporting grounds, ski resorts and the like. Use of hydrotherapy vessels for “dry treatments” will dramatically increase the marketability of these vessels in areas outside of those traditionally exploited such as health clubs and spas.

It is anticipated that various cosmetic or therapeutic substances could be placed in the sheath, or applied directly to the skin of a user before entering the sheath. Substances such as moisturiser, milk, sea water, mud, oils, medicaments, therapeutics etc. can be used for various therapeutic or relaxation effects. The hydrostatic pressure applied to the skin (via the wall of the sheath) along with the temperature of the water can assist in the penetration of these substances into the skin of the user. As an example, Herbs can greatly enhance the therapeutic value of a hydrotherapy treatment for a variety of illnesses and minor discomforts.

Herbs may be used as essential oils. Oils can be combined to enhance their therapeutic value. Marjoram (Origanum majorana) is good for relieving sore muscles; juniper (Juniperus communis) is recommended as a detoxifying agent for the treatment of arthritis; lavender, ylang ylang (Conanga odorata), and chamomile (Chamaemelum nobilis) are recommended for stress relief; cypress (Cupressus sempervirens), yarrow (Achillea millefolium), geranium (Pelargonium graveolens), clary sage (Savlia sclaria), and myrtle (Myrtus communis) can promote healing of hemorrhoids; and spike lavender and juniper (Juniperus communis) are recommended for rheumatism.

It will be appreciated that use of the sheath has the added advantage that only a minimal amount of cosmetic or therapeutic substance is required while still providing a similar practical effect to the user being completely immersed in the substance. The even compression of the surrounding water acting an the sheath results in very close conformance of the sheath to the shape of the users body. Accordingly, only a thin film of cosmetic or therapeutic substance is required to fill the space between the user's skin and the inner surface of the sheath.

It is further contemplated that the sheath may be double-walled, at least in part. This arrangement would allow water of various temperatures to be pumped in and out of the sheath allowing precise temperature control to distinct parts of the body, and also “thermal contrasting” where the temperature of a tissue is rapidly altered. The double-walled arrangement will also allow a fluid or a gas to be injected into the sheath at pressure, thereby compressing the underlying tissue. Compression therapy is further discussed infra.

The user could also be exposed to steam during the hydrotherapy session. Steam can be generated by means of boiling water and directing the steam from it into the hydrotherapy vessel. Hot water mist may be generated simply by pressurized (mains water pressure or pump assisted) hot water dispersed through one or more spray nozzles. The hot water being sprayed through nozzles atomizes creating a steam effect in the apparatus. Ultrasonic vibration may also be used to generate a mist. Alternatively, the user could choose to use a dry heat, such as that provided by an infra red lamp.

The user may be exposed to a mist containing a fragrance or medicament. The means for delivering a mist could be the same or similar to that provided in the Micro Mist system (manufactured by Takara Belmont Corporation, Japan) whereby the mist consists of tiny particles of hot water at a fixed temperature generated through ultrasonic vibration. Unlike steam or boiled water, the temperature of the ‘mist’ can easily be controlled so that customers can stay comfortable throughout their treatment time.

The vessel may further include a means for moving air about the head of the user, such as a fan. The fan may be used to facilitate the even distribution of steam, water vapour, atomized water or mist about the head of the user. The means for moving air may also be used to assist in controlling the temperature in the environs of the head. The fan may also include means for heating and cooling the air.

A number of other contrivances may be included in or on the walls, roof, or floor of the vessel to provide other cosmetic or therapeutic treatments. For example, the vessel may be fitted with a number of spray nozzles that could dispense artificial tanning composition, or a therapeutic composition. A vertical row of water jets could also be included to provide a Vichy shower effect in the vessel.

One form of the invention includes two separate tanks for storing water, the tanks containing water of different temperatures. This arrangement will allow for cycling the temperature from high to low by pumping warm water from a first tank into the vessel, returning the warm water to the first tank, pumping cool water from a second tank into the vessel, and returning the cool water to the second tank, and repeating the entire process. It is contemplated that use of a series of tanks may be of benefit such that the user can experience a broad range of discrete temperature changes during the course of a treatment.

In another aspect, the present invention provides a method for providing hydrotherapy, the method including use of a hydrotherapy vessel as described herein. It is contemplated that the method may be implemented in the home, in a hospital, in an alternative medicine setting, in a holiday resort, in a health club, or in a relaxation centre. The method may be used alone or as an adjunct to other therapies such as massage or physiotherapy.

In a further aspect the present invention provides a kit for converting a hydrotherapy vessel of a depth sufficient to allow upright hydrotherapy without means for lateral entry by a user into a hydrotherapy vessel including means for lateral entry by a user. The kit may include components such as a door, means for forming a seal between the door and wall of the hydrotherapy vessel, and instructions.

Yet a further aspect of the present invention provides a method for converting a hydrotherapy vessel of a depth sufficient to allow upright hydrotherapy without means for lateral entry by a user into a hydrotherapy vessel including means for lateral entry by a user. Preferably, the method includes the use of a kit as described herein.

Still a further aspect of the present invention provides a replacement part when used for repairing the means for forming a seal between the wall and door of a hydrotherapy vessel of a depth sufficient to allow upright hydrotherapy as described herein.

The present invention provides significant advantages with respect to water conservation. Water is a valuable resource in short supply and many hydrotherapy treatments waste large volumes (up to 1,000 litres). The water may be wasted because of the continuous application of pressurised water to the user (e.g. Vichy shower), because the hydrotherapy vessel is large, or because a hydrotherapy vessel must be drained, washed and refilled between every user to prevent cross-contamination. Implementation of upright hydrotherapy as provided by the present invention requires significantly less water than. Firstly, an upright hydrotherapy vessel may require less water than a vessel used for traditional hydrotherapy where the user is in a supine position. Secondly, where the upright hydrotherapy vessel is used in combination with sheath there is no need to drain, wash and refill the vessel between users. This is because the user's skin never actually contacts the water in the vessel. It is well known in the hydrotherapy field that vessels can harbour and transmit infection (such as mycobacterium species) to users. This is partially overcome in practice by incorporating rigorous cleaning protocols (often using toxic chemicals). However the need for repeated draining, cleaning, and refilling is almost completely obviated by use of the sheath. In many circumstances, the only water consumed by each user will be that used by a hand shower that may be incorporated into the vessel. This may amount to as little as 30 to 40 litres of water per user.

The reuse of water is simplified in embodiments of the invention that incorporate water storage tanks in the walls and/or floor since water can be easily removed from the vessel interior to allow a first user to exit and a second user to enter, and to then refill the vessel.

The vessel and/or sheath and/or liner described herein is suitable for use in a range of physical therapies. For example, compression therapy has been administered in the prior art by the use of bandages and compression hosiery. Compression therapy works by applying controlled pressure to the surface veins, keeping their diameter small and forcing blood back into the deep vein system which in turn pushes the blood “uphill” towards the heart. Improved blood flow aids in the healing of active ulcers and in preventing ulcer recurrences. This therapeutic modality may also be used in the treatment and minimisation of scar tissue, and to assist in the healing of many sports injuries. The present invention provides a new means of administering compression therapy to any part of the body. Instead of using bandages and hosiery to compress the tissue to be treated, it is the pressure of the water inside the vessel (possibly augmented by water jets) that act to compress the tissue.

The vessel of the present invention may also be suited to administering a special form of compression therapy known as lymphatic drainage. In this therapy, the tissues are compressed in a wave-like fashion to “squeeze” lymph (and associated toxins) from the tissues. It will be appreciated that this effect could be carried out by raising and lowering the water level in the vessel. The increasing water level will sequentially compress tissue, leading to the extravasation of lymph from the tissue.

Other physical therapies for which the present invention will be useful include the various forms of “aquasize” where the user performs an activity while upright and substantially immersed in water. The viscosity of the surrounding water provides resistance to the user's movements thereby increasing the health benefit. The user may choose to wear hand paddles or flippers to further increase the resistance during aquasize. The use of flippers may require the depth of the vessel to be increased accordingly. It is contemplated for example that an exercise bicycle could be attached to the floor of the vessel, with the spokes of the bicycle being equipped with fins or paddles to increase resistance.

It will be appreciated that vessels as described herein may be used outside of the cosmetic or therapeutic field. It is contemplated that the vessels may be also be used for amusement. A virtual environment could be established by the use of the various visual, auditory and olfactory stimulating devices described herein. For example, a rescue from the Titanic could be simulated by pumping cold water into the vessel, displaying images of a sinking ship on a DVD display screen, emitting flashes from a strobe light to simulate lightening, injecting the odour of diesel fuel into the vessel and the like. The water in the vessel could be changed to warm, once the user has been “rescued” at the end of the simulation.

It will also be apparent that substances other than water can be used in the vessel. For example muds, sands, slurries, gels, salt solutions and other concoctions are contemplated.

In consideration of the above it is clear that a substantial advantage of the present invention is that a single vessel can be used to serve many purposes. The upright nature and ability to laterally enter the vessels described herein in are central to the multi-use capability. For example, the vessel may be used as a steam room or tan spray booth once emptied of water. This would not be practical with a hydrotherapy vessel of the prior art such as a traditional spa bath since it would be necessary to completely enclose the top of the bath in order to properly contain the steam or spray tan, and further more it would not be of sufficient depth for the user to stand. By contrast, the vessels claimed herein can be completely enclosed from the top permanently if required (since entry is from the side), or if a lid is required, it would only need to be relatively small therefore being easily managed.

The invention will now be described by reference to the accompanying non-limiting drawings.

### DETAILED DESCRIPTION OF THE INVENTION

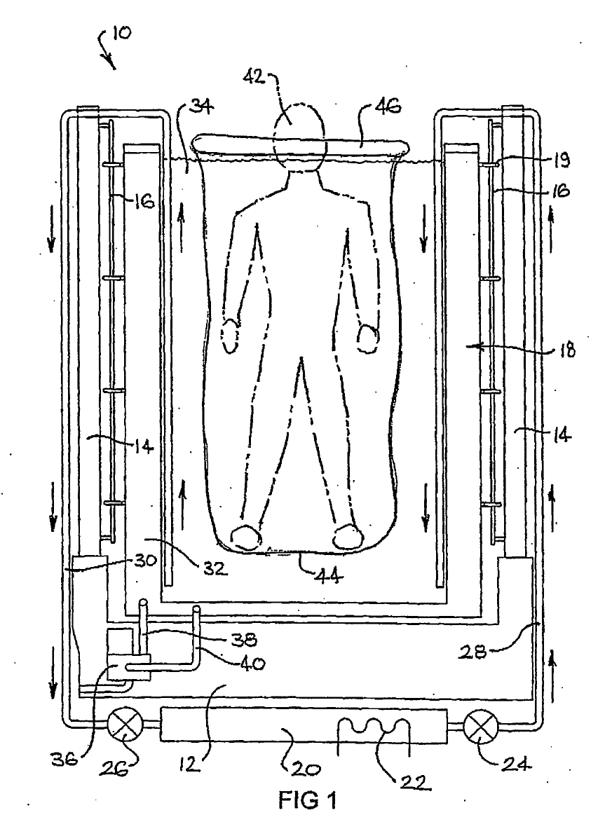

An exemplary embodiment of the apparatus for providing a hydrotherapy vessel is shown generally at 10 FIG. 1. In the preferred exemplary embodiment illustrated in FIG. 1, the main structural components are the base 12 and upright members 14. Support rails 16 are fixed to the upright members 14 allowing attachment of the vessel liner 18. The liner 18 is watertight, and because it is manufactured from a flexible material is able to collapse flat. Water is stored in a tank 20 having a heater 22 to preheat water before use. Water in the tank is pumped into the vessel by the pump 24 and conduit 28. Conversely, water may be removed from the vessel by the pump 26 via the conduit 30. The liner is of a hollow construction having a cavity 32 allowing water or air to be pumped into or removed from the liner via the pump 36 and conduits 38 and 40. The effect of pumping air or water into the cavity 32 is to increase the rigidity of the wall, leading to movement of the liner in an upward direction, being guided by the support rails 16. The embodiment shown in FIG. 1 illustrates the situation where the cavity 32 is completely inflated. Upon inflation, the liner 18 can be filled with water 34 from the tank 20 via the pump 24 and conduit 28. In use, the user 42 is inside a flexible sheath 44, having a buoyant rim 46 that maintains the edge of the sheath above the surface of the water.

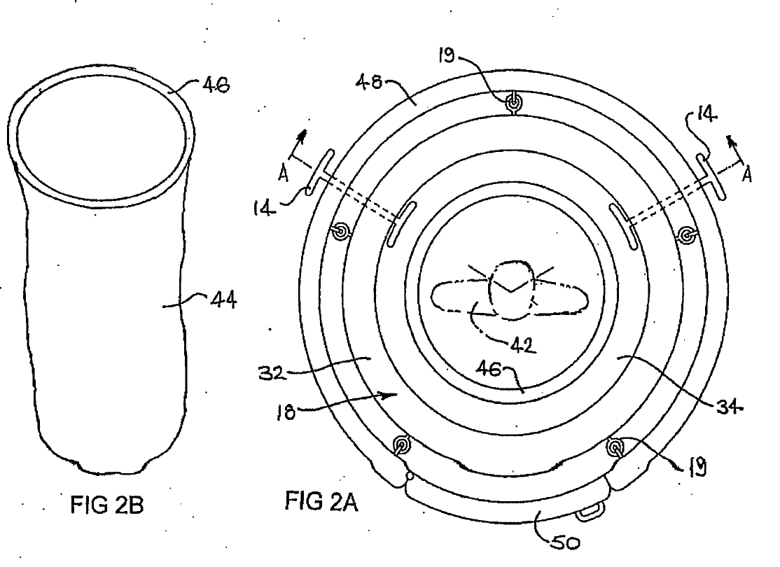

FIG. 2A illustrates a plan view of the exemplary embodiment of FIG. 1. From this view there is the further feature of the external wall 48 having an outward opening door 50. In this embodiment the door 50 is the entry/text means by which the user enters or leaves the vessel.

Typically, at the commencement of a hydrotherapy session, the liner 32 is flaccid, and therefore capable of holding little or no water. The sheath 44 sits within the circumference of the liner 32 with the opening of the sheath 44 facing upward. The user opens the door 50 and steps over the liner 32 and into the opening of the sheath 44. The door 50 is then closed, and the pump 38 is activated to inflate the liner 32, causing it to become rigid and causing the walls to rise. Once completely inflated the liner 32 forms a watertight vessel with substantially upright walls. At this point the user is standing in the centre of the sheath 44, the rim of the sheath 46 still resting on the floor of the liner 32, with the floor and walls of the liner forming a watertight vessel about the user. Pump 24 is then activated causing movement of water from the tank 20 into the lumen of the liner 32 via the conduit 28. As the water level rises, the sheath rim 46 also rises (given its floatation properties) thereby 30 maintaining the rim 46 above the surface of the water. This acts to maintain the user in a substantially dry state during hydrotherapy. The user is now enclosed within the sheath 44 and floating above the floor of the liner 18. The user feels the pressure and temperature of the water through the sheath 44.

In reality, the sheath will contour more closely to the body than that illustrated given the water pressure and flexibility of the sheath wall.

At the conclusion of the hydrotherapy session, pump 26 is activated causing the egress of water 34 from the lumen of the liner 18. The water 34 returns to storage tank 20 for reuse.

FIG. 2B illustrates a preferred embodiment of the sheath 4 having a buoyant rim 46.

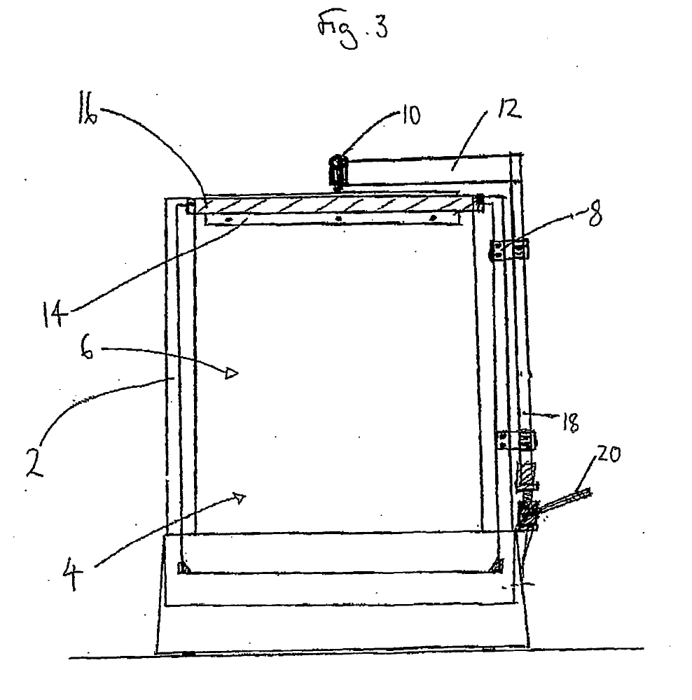

An exemplary embodiment of the apparatus for providing a hydrotherapy vessel is shown generally in FIG. 3. The assembly is mounted on a surface shown generally at 2, having an aperture 4. The door 6 is mounted on a hinge 8 such that the door 6 is able to move in an upwards direction. The hinge 8 is attached to a swivel joint 10 by a cross member 12. The door 6 is fitted with a steel plate fabricated channel 14 to which a removable panel 16 is attached. The hinge spindle 18 is fitted with a lift 20.

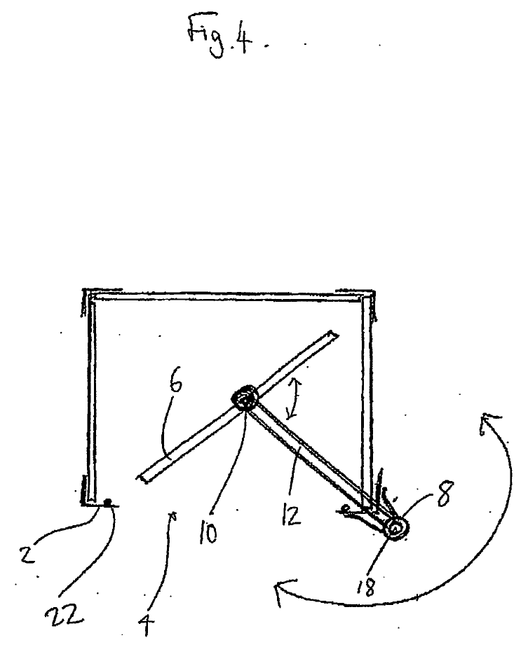

The plan view of FIG. 4 shows additionally the rubber seal 22 against which the door 6 abuts to create the seal when in the closed position.

In the closed position the removable panel 16 is in place to form the aperture 4. If it is necessary to open the door outwards then the removable panel 16 is removed to leave a lengthened aperture. The door will still not swing outwards however because, in part, the lower edge of the door is still in contact with the lower lip of the aperture. To correct this, the lift 20 is actuated to raise the door 6 just enough so that the lower edge of the door now clears the lower lip of the aperture, but not so much that the upper edge of the door contacts any other superior structure. After this step of raising the door 6, the door 6 is pivoted on its longitudinal axis by the swivel joint 10 such that the entire door can now pass through the aperture.

It is contemplated that the skilled person will be able to conceive of alternative apparatus and methods for implementing the invention described herein.

Such alternative methods are considered to fall within the scope of the invention described herein.

1. A substantially watertight hydrotherapy vessel including a wall, the wall defining an interior of the vessel, the wall including means for allowing lateral entry of a user into the interior of the vessel, wherein the vessel is of a depth sufficient to allow upright hydrotherapy.

2. A vessel according to claim 1 wherein the vessel is of sufficient depth to accommodate a user's body that is in a substantially extended state and the line of the body defines an angle of at least about 20 degrees with the ground during the hydrotherapy session.

3. A vessel according to claim 1 wherein the vessel is of sufficient depth to accommodate a user's body that is in a substantially extended state and substantially perpendicular to the ground during the hydrotherapy session.

4. A vessel according to claim 1 wherein the vessel is of sufficient depth to accommodate a user's body that is substantially upright but not necessarily in a substantially extended position.

5. A vessel according to claim 1 wherein the vessel is of sufficient depth to allow the user to float free of the floor of the vessel and wherein the user is in a substantially upright position.

6. A vessel according to claim 1 wherein the user is about average adult height.

7. A vessel according to claim 1 wherein the vessel is capable of containing water to a depth of more than about 1.2 metres.

8. A vessel according to claim 1 wherein the vessel is capable of containing water to a depth of more than about 2 metres.

9. A vessel according to claim 1 wherein the vessel is capable of containing water to a depth of more than about 2.2 metres.

10. A vessel according to claim 1 wherein the means for allowing lateral entry is a hinged door capable of forming a watertight seal with the wall when closed.

11. A vessel according to claim 1 wherein the means for allowing lateral entry is an aperture in the wall.

12. A vessel according to claim 1 wherein the wall completely surrounds the means for allowing lateral entry.

13. A vessel according to claim 1 wherein the means for allowing lateral entry includes means for sealing the means for allowing lateral entry.

14. A vessel according to claim 1 wherein the wall includes means for sealing the means for allowing lateral entry to the vessel.

15. A vessel according to claim 1 wherein the wall is adapted to store water and allow delivery of water to and/or from the vessel.

16. A vessel according to claim 1 wherein the floor of the vessel is adapted to store water and allow delivery of water to and/or from the vessel.

17. A vessel according to claim 1 including one or more hydrotherapy jets adapted to massage the body of the user.

18. A vessel according to claim 1 including a mirror adapted to allow the user to observe an area lateral to vessel.

19. A vessel according to claim 1 including means for generating steam, mist or vapour.

20. A vessel according to claim 1 wherein the steam, mist or vapour includes a fragrance or a medicament.

21. A vessel according to claim 1 including means for moving air about the head of the user.

22. A vessel according to claim 1 including two separate tanks for storing water, the tanks adapted to contain water of different temperatures.

23. A liner for use in a hydrotherapy vessel according to claim 1, wherein the liner is capable of forming a substantially watertight barrier such that water is unable to escape from the vessel through the means for allowing lateral entry.

24. A sheath for use in a hydrotherapy vessel according to claim 1, wherein the sheath is capable of receiving a user.

25. A sheath according to claim 24 wherein the sheath is substantially sock shaped.

26. A sheath according to claim 24 composed of a material of minimal thickness and/or with sufficient flexibility and/or sufficient heat transfer properties to allow the wall of the sheath to closely conform to the contours of the body, and/or to allow the sensation of pressure and/or temperature to the skin.

27. A sheath according to claim 24 including a buoyant rim at or toward the open end.

28. A method for providing hydrotherapy including use of a vessel according to claim 1.

29. A method according to claim 28 wherein the hydrotherapy is selected from the group consisting of relaxation therapy, compression therapy, and lymphatic drainage therapy.

30. A kit for converting a hydrotherapy vessel without means for lateral entry by a user into a vessel according to claim 1.

31. A kit according to claim 30 including one or more components selected from the group consisting of a door, a means for forming a seal between the door and wall of the hydrotherapy vessel, and a set of instructions.

32. A method for converting a hydrotherapy vessel without means for lateral entry by a user into a hydrotherapy vessel including means for lateral entry by a user including use of a kit according to claim 30.
